(19) United States
(12) Patent Application Publication
(10) Pub. No.: US 2026/0285593 A1
(43) Pub. Date: Sep. 24, 2026

(54) A RAIL SYSTEM, PARTICULARLY FOR AN AUTOMATED STORAGE AND RETRIEVAL SYSTEM FOR STORAGE AND RETRIEVAL OF CONTAINERS

(71) Applicant: AutoStore Technology AS, Nedre Vats (NO)

(72) Inventor: Trond Austrheim, Etne (NO)

(21) Appl. No.: 19/477,455

(22) PCT Filed: Apr. 25, 2024
(86) PCT No.: PCT/EP2024/061392

§ 371 Date: Oct. 21, 2025

(30) Foreign Application Priority Data
Apr. 28, 2023 (NO) 20230487

(51) Int. Cl. B65G 1/04; E01B 23/04

(52) U.S. Cl. CPC B65G 1/0464; E01B 23/04

(57) ABSTRACT

A rail system comprising: a first beam and a second beam each comprising a respective upper surface configured to provide a track, a respective pair of sidewalls extending downwards from the respective upper surface and defining a lateral extent of the respective beam, a respective cut-out extending through the respective pair of sidewalls defining a respective cut-out volume extending through the lateral extent of the respective beam and wherein the first beam and the second beam are arranged perpendicular to one another, with the first beam uppermost and the second beam underneath, and the cut-outs of both beams aligned, such that the first beam and the second beam interlock and the first upper surface and second upper surface lie in a single plane, and wherein the rail system comprises a locking arrangement configured to lock the beams together.

### TECHNICAL FIELD

The present disclosure relates to a rail system, for example a rail system for an automated storage and retrieval system for storage and retrieval of containers.

### SUMMARY

This summary is provided to introduce in simplified form a selection of concepts that are further described herein. The summary is not intended to identify key or essential features of the invention.

The present disclosure is set forth and characterized in the independent claims, while the dependent claims describe other characteristics of the disclosure.

In one aspect, the present disclosure is related to a rail system comprising:

a first beam comprising:
a first upper surface configured to provide a first track,
a pair of first sidewalls extending downwards from the first upper surface and defining a lateral extent of the first beam,
a first cut-out extending through the pair of first sidewalls, defining a first cut-out volume extending through the lateral extent of the first beam, wherein the first cut-out volume extends upwards from a lowermost edge of the first beam,
   a second beam comprising:
a second upper surface configured to provide a second track,
a pair of second sidewalls extending downwards from the second upper surface and defining a lateral extent of the second beam,
a second cut-out extending through the pair of second sidewalls, defining a second cut-out volume extending through the lateral extent of the second beam, wherein the second cut-out volume extends downwards from an uppermost edge of the second beam,
   wherein the first beam and the second beam are arranged perpendicular to one another, with the first beam uppermost and the second beam underneath, where they intersect: the first and second cut-outs aligned, such that part of the second beam is received underneath, under the first beam within the first cut-out volume, and part of the first beam is received uppermost, above the second beam within the second cut-out volume, such that the first beam and the second beam interlock and the first upper surface and second upper surface lie in a single plane, the single plane most preferably being horizontal,
   and wherein the rail system comprises a locking arrangement configured to secure the first beam and the second beam together at least against relative movement in a vertical direction.

The rail system of the present disclosure is intended to be used preferably for an automated storage and retrieval system for storage and retrieval of containers. Such an automated storage and retrieval system may comprise the above-described rail system, the beams providing a first set of straight and parallel rails arranged to guide movement of container handling vehicles in a first direction across the top of a frame structure, and a second set of straight and parallel rails arranged perpendicular to the first set of rails, arranged to guide movement of the container handling vehicles in a second direction which is perpendicular to the first direction, the first and the second set of rails thus crossing each other at the respective cut-outs and thus forming a rail grid.

The rails are formed by the beams. Each beam may be formed as a continuous one-piece part.

Preferably, the first and second upper surface of the beams are configured to provide respective two parallel tracks, one on either side of the lateral extent of the upper surface, one on the left side and one on the right. For instance, three vertical edges, preferably extending along the whole length of the respective beam, are formed on the respective upper surface, preferably one in the middle separating the left and right rail and one on either side of the lateral extent of the upper surface limiting the left and right rail laterally to the respective side. Preferably, at least one of these three vertical edges form the uppermost edge.

The first and second sidewalls may optionally be termed a first and second side or a first and second vertically extending side.

As discussed above, a first and second beam are arranged perpendicular to one another, and at their respective crossing, both beams comprise a cut-out, in the first beam extending from the bottom upwards and in the second beam from the top downwards. The presence of the cut-outs allows the first and second beams to interlock each other, when the two cut-outs of the crossing beams are shifted into each other by a vertical relative mounting movement. Accordingly, each cut-out in a crossing beam forms a volume which receives at least part of the other beam, this part of the other beam aligning with its own cut-out in a height (vertical) direction.

All the wording regarding locations and directions, like “vertical”, “top”, “uppermost”, relate to the optional intended use and optional intended orientation of the system. In such an optional orientation, the rail grid most preferably is horizontal, and the first and second tracks lie in a single horizontal plane.

As discussed above, optionally all the beams forming the rail grid in both perpendicular directions may be single-piece parts. Compared to the prior art, embodiments of the present disclosure in which all beams are single-piece parts result in simplified construction, reduce the amount of parts needed, improve the security of the rail grid and reduce the amount of maintenance needed in operation of the rail grid. Consequently, such a rail grid may be constructed and maintained at a reduced price compared to prior art rail grids.

The cut-outs of two beams crossing each other provide for a form fit as described, preferably in clearance fit between the two beams.

Optionally, the height of the first beam and the height of the second beam are equal. The “height” of the beam being referenced here is the full height of the beam, not the regions where cut-outs are provided. Preferably, cross-sections of the first and the second beam, except along the cut-outs, are identical—and, further preferably, this applies to all cross-sections of the first and the second beam except for those cross-sections comprising laterally oriented structures like, for instance, drilled holes or the cut-outs.

Preferably, the first cut-out extends upwards and the second cut-out extends downwards to a respective first and second surface which are complementary to each other—and most preferably horizontal—and which contact each other when the first and the second beams interlock. The latter allows forces to be transmitted through these contacting surfaces.

Most preferably, the first cut-out extends upwards and the second cut-out extends downwards to the same level at about half the height of the respective beam or between 40% and 60% of the height.

The beams preferably comprise extruded hollow chamber profiles. Further preferably, the extruded hollow chamber profiles comprise two hollow chambers above each other and limited against each other by at least one wall bridging the lateral extent of the respective beam extending between the pair of sidewalls of the respective beam. Preferably, the wall is located at about half the height of the respective beam or at a level between 40% and 60% of the height. Most preferably, the wall is located at the level to which the first and the second cut-out extend.

The beams are optionally formed from an alloy comprising aluminium or an alloy comprising another “light metal” such as magnesium and/or titanium. A “light metal” is defined herein to be one having a density below 5 g/cm3.

Outer contours of the cross section of the beams optionally follow the shape of a rectangle.

In particular, if the outer contours of the cross section of the beams follow the shape of a rectangle, outer contours of the cut-outs, as seen from the side of the respective beam, preferably follow the shape of a rectangle, too. Preferably, the cut-out width (i.e. the dimension of the cut-out in the direction of the extension of the respective beam) is the same as the lateral extent of the respective crossing beam.

As noted above, the rail system comprises a locking arrangement configured to secure the first and second beams together at least against relative movement in a vertical direction. The locking arrangement preferably comprises a form-fitting locking member configured to sit partially within a first form-fitting structure of the first beam and partially within a second form-fitting structure of the second beam, in order to secure the first and second beams together form-fittingly. The locking member is preferably made of a plastic material like a thermoplastic (for example, PP, HDPE, etc.).

Preferably, the at least one first form-fitting structure is a first groove provided in at least one of the pair of first sidewalls of the first crossing beam, and the at least one second form-fitting structure is a second groove provided in at least one of the pair of second sidewalls of the respective other crossing beam. The first groove and/or the second groove optionally are grooves in the sidewalls which extend in a longitudinal direction of the beams, the grooves being formed as part of an extruded profile of the beams.

The first groove and the second groove optionally lie in one plane which is parallel to the single plane.

Optionally, the beams and the locking member comprises a locking structure configured to lock the locking member against horizontal movement in its locking position by means of a snap fit connection and/or a form fit connection.

The form fit connection of the locking structure may be an attachment hole located within the first or the second groove, and a pin of the locking member configured to extend through the attachment hole. Accordingly, the locking member is configured to sit partially within the first groove and partially within the second groove and the pin extending through the attachment hole.

The form fit connection of the locking structure may also be an upper and/or lower non-snap latch located on the locking member and configured to form-lock behind an edge of the groove in which the locking member sits in its locking position and behind which edge the non-snap latch is arranged to be placed through an upper and lower gap in the edge.

The snap fit connection of the locking structure may comprise an upper and/or lower snap locking latch located on the locking member and configured to snap behind an edge of the groove in which the locking member sits in its locking position.

Preferably, the locking member is L-shaped, and the respectively mentioned locking structure is located on one of the two legs of the locking member.

So, mounting the locking member is simple and may preferably be accomplished by hand without a tool. The locking structure may comprise snapping structures and form fitting structures, which hold the member in the first and/or second groove.

The locking member preferably comprises a first leg and a second leg, as said, these legs extending perpendicularly to one another, i.e. the locking member has an L-shaped structure. The first leg and/or the second leg may have a width which corresponds to the depth of the groove into which the member is prepared to fit and to sit so that the legs sit flush or substantially flush with the side wall of the beam when installed in the groove (for instance, it might be recessed in the groove). In this way the first leg and/or the second leg do not pose an obstruction to a storage container being raised or lowered in a column defined by the rail grid. The first leg may be of a height which extends the height of the groove while the second leg might have a different structure, for example, comprising an extension which can be flicked out from within the other groove to facilitate the member's removal. The locking member may be made of a material which is resilient, for example, it might be made of plastics or a rubberized material which is sufficiently compliant to allow the legs of the member to be pushed into the respective grooves.

In these or earlier mentioned embodiments, the first and/or second beams may be formed with a single-track profile or a double track profile (for instance, to allow wheels of different vehicles to pass one another on the same rail). Optionally, both the first and second beams are provided with a double track profile, so that wheels of different vehicles may pass one another on all four sides of grid space of the rail grid.

In a further aspect, the present disclosure provides an automated storage and retrieval system for storage and retrieval of containers, comprising:
a frame structure,
the rail system of the first aspect, optionally including any optional features thereof; and
a plurality of container handling vehicles, wherein the first set of parallel rails are arranged to guide movement of the container handling vehicles in a first direction across the top of the frame structure, and the second set of parallel rails are arranged to guide movement of the container handling vehicles in a second direction.

Preferably in this storage and retrieval system, the second beams comprise attachment means for attaching each second beam to the frame structure.

In another aspect, the present disclosure provides a method of assembling a rail grid of an automated storage and retrieval system, by mounting first and second beams,

the first beams comprising:
a first upper surface configured to provide a first track,
a pair of first sidewalls extending downwards from the first upper surface and defining a lateral extent of the first beam,
a first cut-out extending through the pair of first sidewalls, defining a first cut-out volume extending through the lateral extent of the first beam, wherein the first cut-out volume extends upwards from a lowermost edge of the first beam, and
   the second beams comprising:
a second upper surface configured to provide a second track,
a pair of second sidewalls extending downwards from the second upper surface and defining a lateral extent of the second beam, a second cut-out extending through the pair of second sidewalls, defining a second cut-out volume extending through the lateral extent of the second beam, wherein the second cut-out volume extends downwards from an uppermost edge of the second beam,
   by are arranging the first beams and the second beams perpendicular to one another, with the first beam uppermost and the second beam underneath, where they intersect: aligning the first and second cut-outs, receiving part of the second beam under the first beam within the first cut-out volume, and part of the first beam above the second beam within the second cut-out volume, thus interlocking the first beam and the second beam, while arranging the first upper surface and second upper surface in a single plane, arranging the single plane most preferably to be horizontal,
   and securing the first beam and the second beam together at least against relative movement in a vertical direction by means of an accordingly configured locking arrangement.

The method may be further specified by steps and these in particular by means of devices as described herein above.

### BACKGROUND

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, for instance extruded aluminum profiles.

The framework structure 100 of the automated storage and retrieval system 1 comprises a preferably horizontal rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c, 401b, 401c which enable the lateral movement of the container handling vehicles 201, 301, 401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, for instance raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y-and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in for instance WO2015/193278A1 and WO2019/206487A1, the contents of which are incorporated herein by reference.

FIG. 3 shows an alternative configuration of a container handling vehicle 301 with a cantilever construction. Such a vehicle is described in detail in for instance NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, for instance as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, for instance as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (for instance an X direction) may comprise one track and each rail in the other, perpendicular direction (for instance a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. In addition to storage columns 105, there are special-purpose columns within the framework structure. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (for instance to another framework structure or to another automated storage and retrieval system), to a transport vehicle (for instance a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, for instance as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, for instance monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

The rail system 108 is known to be made from beams which are extruded hollow chamber profiles formed from an aluminium alloy. To form the grid-shaped rail system 108, a first plurality of such beams extends the full length of the rail grid of the rail system 108 in one of the two perpendicular horizontal directions. Each beam is a single-piece part. To form a rail in the other of the two perpendicular horizontal directions, a plurality of beam sections are attached to span the gaps between each adjacent pair of the first plurality of beams. The multi-section beam then extends the full length of the rail grid of the rail system 108. A plurality of such multi-section beams are constructed, to form the plurality of rails in the other of the two perpendicular horizontal directions.

As discussed above, each beam section must be attached to the adjacent pair of the first plurality of beams. The attachment must be in a geometrically precise alignment to form a properly straight second set of rails 111. Current methods of attachment are cumbersome regarding construction, amount of parts, mounting time and effort, security and maintenance, and consequently the price. Screwed flanges are widely used to connect the beam sections between the first one-piece beams 110-the screw connections of which each need to be accurately mounted by installing the screw at a certain torque. Many screw connections are needed for installing the rail sections in the rail grid 108, and this is therefore a very time-consuming process. Moreover, the torque applied to each of the screws needs to be checked at certain time intervals, to guarantee mechanical stability of the framework.

The disclosure is directed to the technical problem of providing a grid-shaped rail system having improved assembly and/or maintenance for example, which is easier or simpler.

### BRIEF DESCRIPTION OF THE DRAWINGS

Following drawings are appended to facilitate the understanding of the disclosure. The drawings show two embodiments of the disclosure, which will now be described by way of example only-each feature of which embodiments, nevertheless, shall be understood as being an aspect according to disclosure also in combination with the subject matter of the disclosure as disclosed in the independent claim and in any combination with features disclosed herein, in other words, also being an aspect according to disclosure in combination with the subject matter as disclosed in the independent claim and in any combination with other features disclosed herein, but without the other features of the respective embodiment shown in the drawings, or in additional combination with only a limited amount of the other features of the respective embodiment shown in the drawings, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 to 9 are perspective views showing mounting steps of crossing beams for an automated storage and retrieval system according to the disclosure.

FIG. 10 is a perspective view of a preferred framework structure for an automated storage and retrieval system.

FIG. 11 to 13 are perspective views showing mounting steps of crossing beams for an automated storage and retrieval system according to an alternative embodiment the disclosure.

FIG. 14 is a perspective view showing the beams of FIG. 11 to 13 not mounted to each other.

### DETAILED DESCRIPTION

In the following, two embodiments of the disclosure will be discussed in more detail with reference to the appended drawings. It should be understood, however, that the drawings are not intended to limit the disclosure to the subject-matter depicted in the drawings.

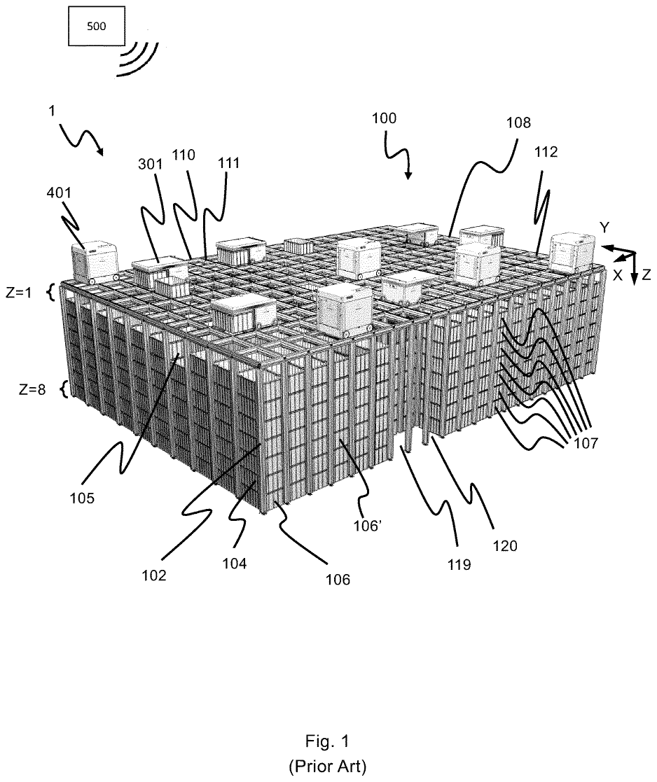

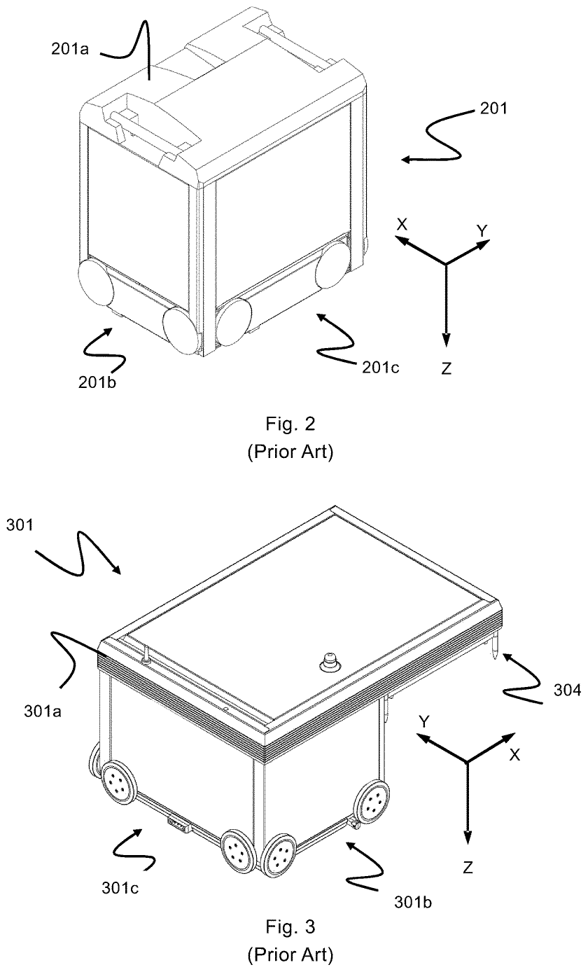

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

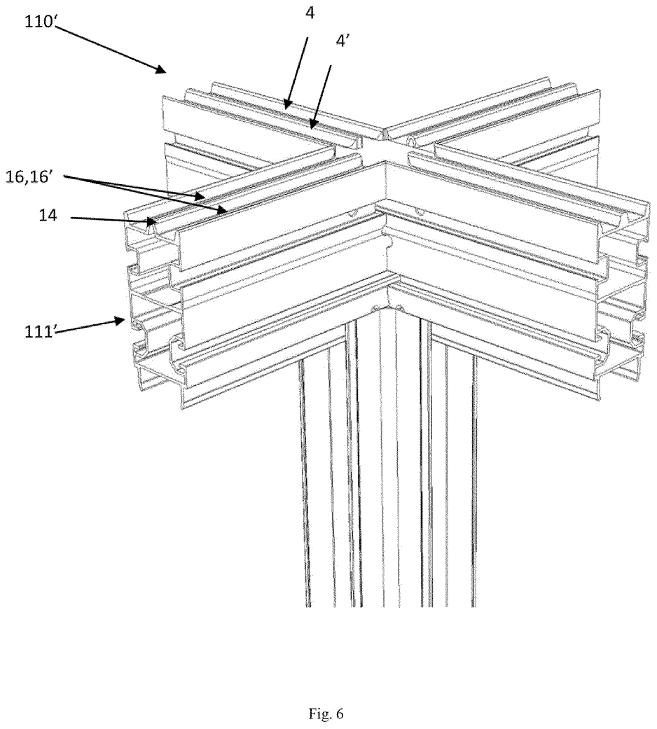

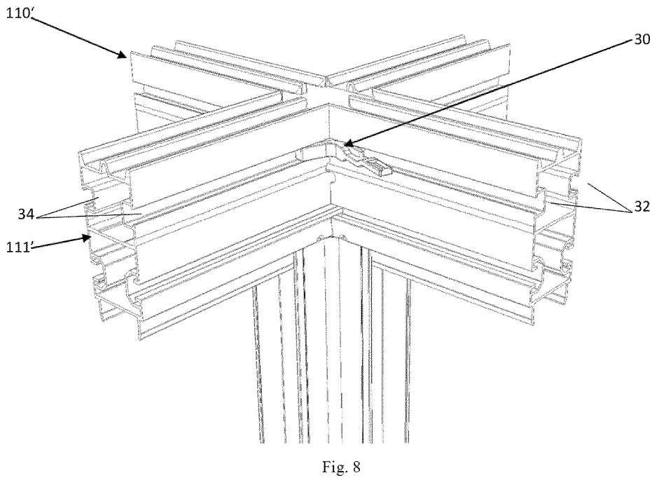

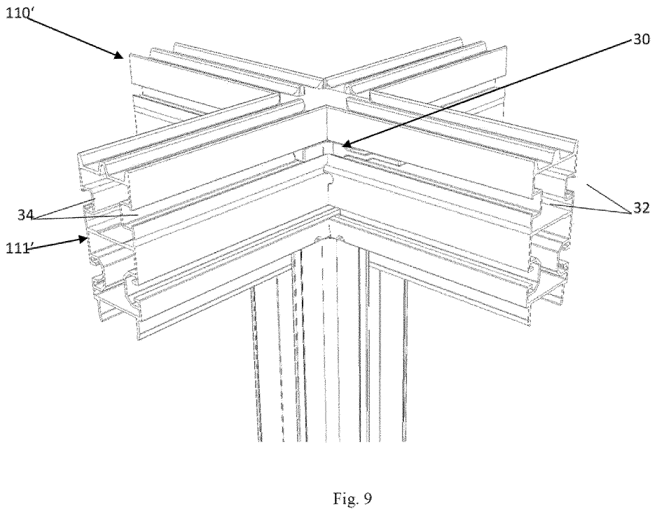

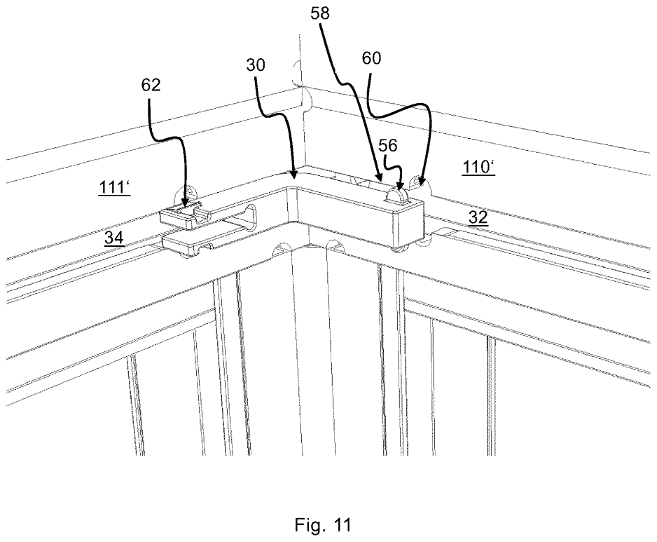

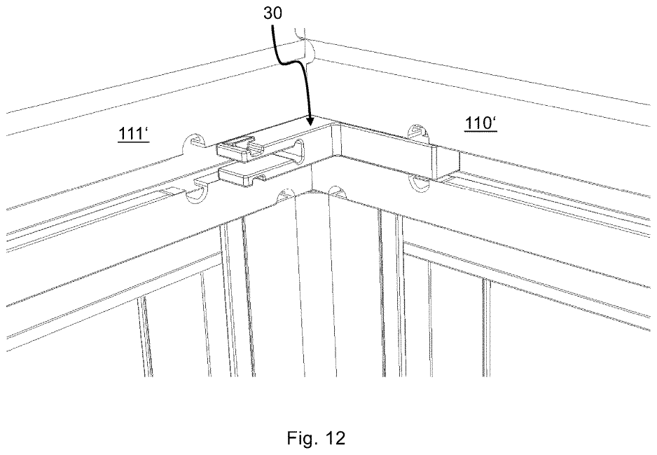

One embodiment of the rail system for the automated storage and retrieval system will now be discussed in more detail with reference to FIGS. 5 to 10, an alternative with reference to FIGS. 11 to 13.

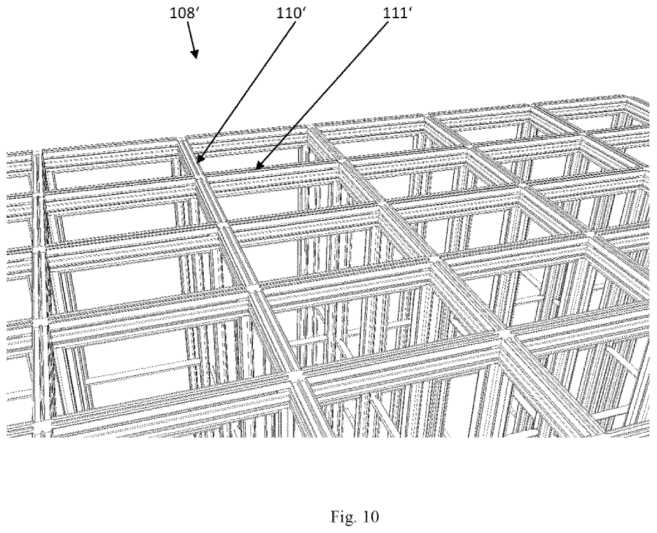

FIG. 5 to 9 and FIG. 11 to 13 show, as a section of a rail system 108′ of Fig. 10, a crossing of two beams 110′, 111′.

The sequence of the FIGS. 5 to 9 shows the step-by-step process of connecting and securing the beams together. The beams extend across the whole rail grid 108′ of the rail system—so, all crossings of the respective beams 110′, 111′ of the two sets of parallel beams, forming the rail grid 108′ of FIG. 10, are mounted as shown in the sequence of FIG. 5 to 9. The crossing beams are secured by means of grooves 32, 34 and locking members 30.

A first beam 110′ of the respective two beams crossing each other comprises
a first upper surface 2 configured to provide at least a first track 4 (or a first set of tracks since the embodiment shown in FIGS. 5-9 features two parallel tracks 4,4′),
a pair of first sidewalls 6 extending downwards from the first upper surface 2 and defining a lateral extent of the first beam 110′ and at least one uppermost edge 8 and at least one lowermost edge 10 of the first beam defining a height of the first beam,
a first cut-out 12 extending through the pair of first sidewalls 6, defining a first cut-out volume 12 extending laterally through the full lateral extent of the first beam 110′, wherein the first cut-out volume 12 extends upwards from the at least one lowermost edge 10 of the first beam,
   a second beam 111′ comprising:
a second upper surface 14 configured to provide at least a second track 16 (or a second set of tracks since the embodiment shown in FIGS. 5-9 features two parallel tracks 16,16′),
a pair of second sidewalls 18 extending downwards from the second upper surface 14 and defining a lateral extent of the second beam 111′ and at least one uppermost edge 15 and at least one lowermost edge 19 of the second beam define a height of the second beam,
a second cut-out 20 extending through the pair of second sidewalls 18, defining a second cut-out volume 20 extending laterally through the full lateral extent of the second beam 111′, wherein the second cut-out volume 20 extends downwards from the at least one uppermost edge 15 of the second beam,
wherein the first and second beams 110′, 111′ are arranged perpendicular to one another, with the first beam 110′ uppermost and the second beam 111′ underneath, and with the first and second cut-outs 12, 20 aligned, such that part of the second beam 111′ is received within the first cut-out volume 12 and part of the first beam 110′ is received within the second cut-out volume 20, such that the first and second beams interlock and the first upper surface 2 and second upper surface 14 lie in a single horizontal plane,
and wherein the rail system 108′ comprises a locking arrangement 30-38 configured to secure the first and second beams together at least against relative movement in a vertical direction, i.e. to at least prevent vertical movement of the first beam relative to the second beam.

This rail system 108′ is intended to be used for an automated storage and retrieval system for storage and retrieval of containers, comprising a first set of straight and parallel rails (beams 110′) providing tracks 4 arranged to guide movement of container handling vehicles in a first direction across the top of a frame structure, and a second set of straight and parallel rails (beams 111′) providing tracks 16 arranged perpendicular to the first set of rails, arranged to guide movement of the container handling vehicles in a second direction which is perpendicular to the first direction, the first and the second set of rails thus crossing each other and forming a rail grid 108′.

Such a system 1 from the state of art was described above as introduction to this application—features of which are also applicable with the disclosure.

The rails are formed by beams 110′, 111′, which respective two beams crossing each other, at their respective crossing, each are formed as a continuous one-piece—because, at their respective crossing, both beams comprise a cut-out 12, 20, in the first beam extending from the bottom 10 upwards and in the second beam from a top edge 15 downwards, the first and second beams interlocking each other, when the two cut-outs of the crossing beams simply are shifted into each other by a vertical relative mounting movement (FIGS. 5 and 6). So, the cut-outs in the respective crossing beams form a volume which comprises at least parts of the volume of the respective other beam along the cut-out of this other beam.

Because the rails of the disclosure are formed by beams 110′, 111′, which respective two beams crossing each other, at their respective crossing, each are formed as a continuous one-piece, each rail-in both of the two perpendicular directions of the rails can be formed by a one-piece beam extending across the whole rail grid of the rail system. Already this allows for decreased efforts with regard to construction, amount of parts, mounting time, security and maintenance, and consequently a reduced price.

The outer contours of the cross section 24 of the cut-out 12, 20 in the respective crossing beam 110′, 111′, as seen in the direction of the extension of the respective other crossing beam, are identical (or rather, for clearance fit, slightly outwardly parallel) to the shape of at least sections of the outer contours 26 of the cross section of the respective other crossing beam 111′, 110′ along its cut-out 20, 12. In other words, the cut-outs of respective two beams crossing each other thus form a form-lock in clearance fit between these two beams.

To allow for a secure, easy and self-explanatory mounting, the height of the first beam 110′ and the height of the second beam 111′ are approximately equal, and the first cut-out 12 and the second cut-out 20 extend, by approximately half of the height respectively, to approximately the middle of the height, the first cut-out 12 upwards from the at least one lowermost edge 10 and the second cut-out 20 downwards from the at least one uppermost edge 15.

The beams 110′, 111′, made of extruded hollow chamber profiles of an alloy comprising aluminium show outer contours of the cross section of the beams broadly following the shape of a rectangle. Also, the contours of the cross section of the cut-outs 12, 20, as seen from the side of the respective beam, follow the shape of a rectangle, too, being of the same width (in the direction of the extension of the respective beam) as the lateral extension of the crossing beam—and extending from the lowermost edge 10 or the uppermost edge 15 of the respective first or second crossing beam by half of the height upwards or downwards, respectively, to the middle of the height of the crossing beam.

As said, in order to secure the interlocked cut-outs 12, 20 of the first and second beam 110′, 111′ and to block the vertical direction of the mounting movement (FIG. 5 to 6) against dismounting into the opposite vertical direction, the rail system 108′ comprises a locking arrangement 30-38 configured to connect the first beam and the second beam including a form-fitting locking member 30, made of a thermoplastic material configured to sit partially within one first form-fitting structure 32 of the first beam and partially within at least one second form-fitting structure 34 of the second beam, in order to secure the first and second beams together form-fittingly into vertical direction.

The first form-fitting structure 32 is a first groove 32 provided in both of the pair of first sidewalls 6 of the first crossing beam 110′, and the second form-fitting structure 34 is a second groove 34 provided in both of the pair of second sidewalls 18 of the respective other second crossing beam 111′. The first groove 32 and the second groove 34 lie in one plane (not shown) which is parallel to the single plane (not shown) of the first upper surface 2 and second upper surface 14 providing for the first and second tracks 4, 16.

And finally, a locking member 30 is configured to sit partially within the first groove 32 and partially within the second groove 34 and comprises, according to a first example, a pin 36 configured to extend, according to the first example, through an attachment hole 38 arranged within the first groove 32 or the second groove 34. In the present embodiment, both the first groove 32 and the second groove 34 are provided with an attachment hole so that the positioning of the locking member 30 is more flexible.

Holes 38 and pin 36 of FIG. 5-9 are a first example of a locking structure (which is configured to lock the locking member, against removal by horizontal movement, in its locking position by means of a snap fit connection and/or a form fit connection) Both holes 38 and pin 36 serve to hold the member 30 in the first and second groove 32, 34. Another example of a locking structure will be described later referring to FIG. 11-13.

Both sidewalls 6, 18 of the first and the second beam 110′, 111′ comprise the locking arrangement 30-38 as follows:
a first upper groove 32 (in contrast to a first lower groove 40 which, in this embodiment, does not function as part of the locking arrangement 30-38) provided in both of the first sidewalls 6, and a second upper groove 34 (in contrast to a second lower groove 42 which, in this embodiment, does not function as part of the locking arrangement 30-38) provided in both of the second sidewalls 18, the upper grooves 32, 34 (of the locking arrangement) of identical cross-section, the first and second upper groove 32, 34 lie in one upper plane (not shown) parallel to the single plane (not shown—and the first lower groove 40 and the second lower groove 42 lie in a lower plane (not shown) parallel to the single plane,
within the first upper groove 32 and the second upper groove 34, left and right from each cut-out 12, 20, equally distanced from the respective cut-out in a horizontal direction, a respective left attachment hole 38 located to the left of the respective cut-out and a respective right attachment hole 38 located to the right the respective cut-out, and all attachment holes 38 of the same diameter and direction of drilling and vertical location within the respective groove 32, 34,
the locking member 30 configured to sit partially within one of the first upper grooves 32 and partially within one of the second upper grooves 34 and to extend through a left or a right attachment hole 38 in one of the first or second upper grooves.

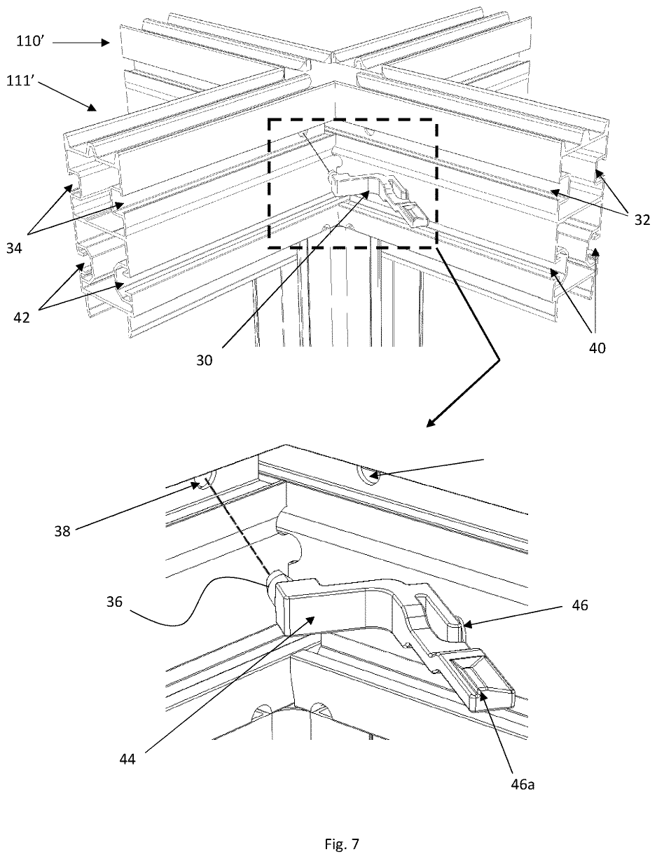

This allows for the beams 110′, 111′, crossing each other and interlocked with their respective cut-outs, to be secured by a very simple final mounting step (FIG. 7-9—in contrast to the vast amount of screws to be mounted and monitored with a lot of effort in the state of art): the pin 36 of the locking member 30 can be placed to extend through any of the attachment holes 38 in the neighborhood (left or right) of a respective cut-out 12, 20: the locking member 30 can be placed in the respective neighboring portions of the first and second upper groove 32, 34. The amount of attachment holes 38 allows for an according amount of possible locations to mount the locking member 30—wherein it is preferred to mount two of them with each crossing of beams, preferably diagonally opposite each other, seen from above (not shown). The amount of attachment holes 38 and the according amount of locations to place the locking member makes it very easy to find the preferred amount of two such locations to place the locking member 30.

Mounting such locking member 30 is simple, by hand without a tool, firstly clicking the pin 36 of the locking member 30 into one of the holes 38 and then, secondly, further into the same direction, clicking one lengthy leg 44 of the locking member 30 carrying the pin 36 alongside into the groove 32, 34 comprising the hole 38, and then, thirdly and finally, clicking, perpendicularly to the side, the other lengthy leg 46 of the locking member 30 (rectangular to the other leg 44 and without the pin 36) alongside into the groove 34, 32 of the other crossing beam 111′, 110′. The other lengthy leg 46 comprises a resilient portion featuring a latching element 46a (i.e. an element providing a snap fit connection in cooperation with one of the first and second upper grooves). The latching element having an edge, the edge interacting with an inner portion or edge of the groove 34,32 in which it is inserted to secure the positioning of the locking member 30.

In the embodiment illustrated in FIGS. 5-9, the locking member is arranged in the upper grooves 32,34 of the beams 110′,111′. In other embodiments, the locking member and corresponding attachment holes may optionally be arranged in the lower grooves 40,42.

An alternative to the holes 36 and pins 38 of FIG. 5-9 is an upper and lower non-snap latch 56 of FIG. 11-13 located on one of the two legs of the L-shaped locking member 30 and configured to form-lock behind an edge 58 of the groove, in which the locking member 30 sits in its locking position and behind which edge 58 the non-snap latch 56 is arranged to be placed through an upper and lower gap 60 in the edge.

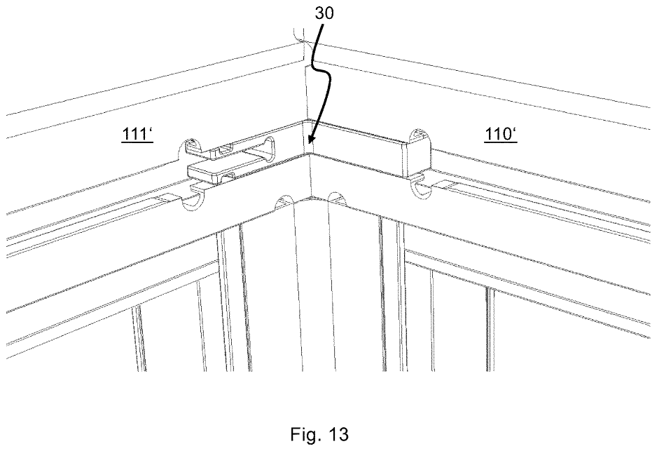

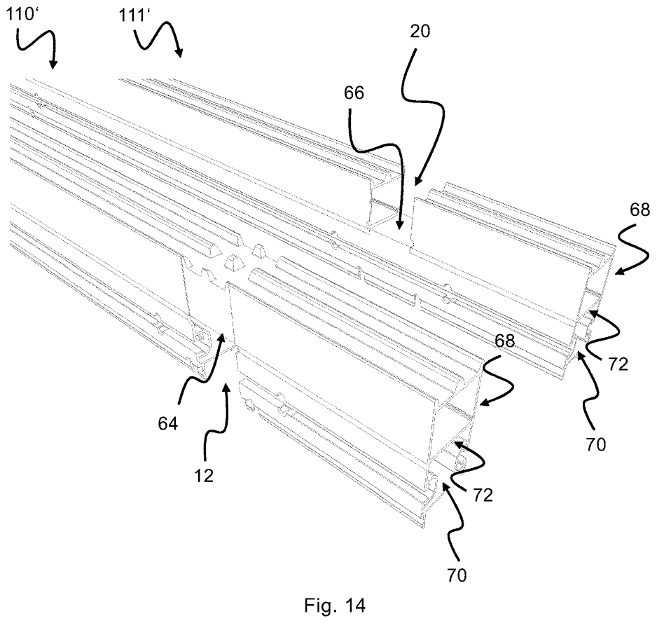

According to the sequence of FIG. 11-13, this example of locking member 30 is mounted into the first and second groove 32, 34 by horizontal translational movements. Locking member 30 then is secured in its final locking position (FIG. 13) by the locking structures, firstly the form fit connection of the said upper and lower non-snap latch 56, and secondly by a snap fit connection formed by a snap latch 62 configured to snap and form-lock behind an edge 58 of the groove, in which the locking member 30 sits in its locking position and behind which edge 58 the snap latch 62 is arranged to snap.

It is noted that the beams 110′,111′ in FIGS. 11-13 have a slightly different design than the beams disclosed in FIGS. 5-9 in that they only comprise a single groove 30,32 on each side. However, the inventive solution is compatible with any type of beam provided the beams comprise a groove, as described above and below, on each of their sides.

Further referring to FIG. 11-13 and to FIG. 5-9, the first cut-out 12 extends upwards and the second cut-out 20 extends downwards to the same level at about half the height and there to a first surface 64 and second surface 66, respectively, which are part of the first the second beam 110′, 111′, respectively, the first surface 64 and the second surface 66 complementary to each other and horizontal and contacting each other when the first and the second beams interlock as shown. This allows forces to be transmitted through these contacting surfaces 64, 66.

Further referring to FIG. 11-13 as to FIG. 5-9, the extruded hollow chamber profiles of the first the second beam 110′, 111′ comprise two hollow chambers 68, 70 above each other and limited against each other by a wall 72 bridging the lateral extent of the respective beam and extending between the pair of sidewalls 6, 18 of the respective beam.

At the respective beams 110′, 111′, the wall 72 forms, along the respective cut-outs 12, 20, the first surface 64 and the second surface 66 (FIG. 14).

In the preceding description, various aspects of the rail system and the automated storage and retrieval system according to the disclosure have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present disclosure. Particularly, features of the embodiment in the figures are disclosed not only in the entirety of the embodiment, but also as single features to be combined freely with other features disclosed in this application.

### LIST OF REFERENCE NUMBERS

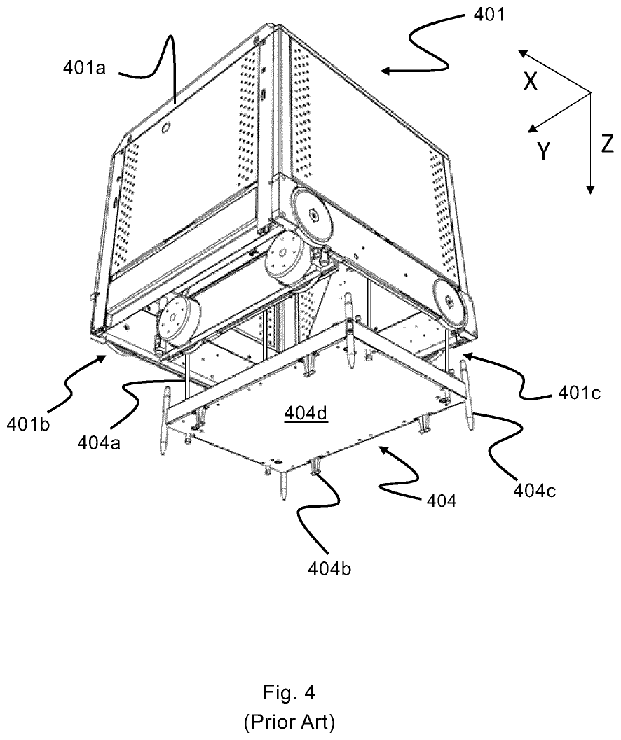

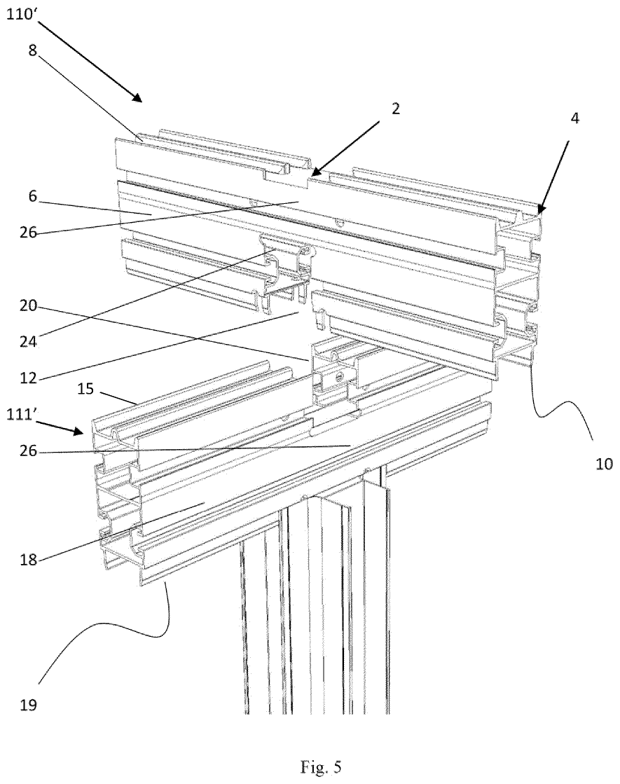

### Prior Art (FIGS. 1-4)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
111 Parallel rails in second direction (Y)
112 Access opening
119 First port column
120 Second port column
201 Prior art container handling vehicle
201a Vehicle body of the container handling vehicle 201
201b Drive means/wheel arrangement/first set of wheels in first direction (X)
2010 Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

### Present Disclosure (FIGS. 5-14)

108′ Rail system
110′ First beam
111′ Second beam
2 First upper surface
4 First track
6 First sidewall
8 Uppermost edge
10 Lowermost edge
12 First cut-out
14 Second upper surface
15 Uppermost edge
16 Second track
18 Second sidewall
19 Lowermost edge
20 Second cut-out
24 Cross section of the cut-out outer contours
26 Beam along its cut-out
30 Locking member
32 Form-fitting structure, first groove
34 Form-fitting structure, second groove
36 Pin
38 Attachment hole
40 First lower groove
42 Second lower groove
44 One leg of the locking member
46 Other leg of the locking member
56 Non-snap latch
58 Edge
60 Gap in the edge
62 Snap latch
64 First surface of beam
66 Second surface of beam
68 Upper hollow chamber
70 Lower hollow chamber
72 Horizontal wall

1.-19. (canceled)

20. A rail system comprising:
a first beam comprising:
a first upper surface configured to provide a first track,
a pair of first sidewalls extending downwards from the first upper surface and defining a lateral extent of the first beam,
a first cut-out extending through the pair of first sidewalls, defining a first cut-out volume extending through the lateral extent of the first beam, wherein the first cut-out volume extends upwards from a lowermost edge of the first beam,
a second beam comprising:
a second upper surface configured to provide a second track,
a pair of second sidewalls extending downwards from the second upper surface and defining a lateral extent of the second beam,
a second cut-out extending through the pair of second sidewalls, defining a second cut-out volume extending through the lateral extent of the second beam, wherein the second cut-out volume extends downwards from an uppermost edge of the second beam,
wherein the first beam and the second beam are arranged perpendicular to one another, with the first beam uppermost and the second beam underneath, and with the first and second cut-outs aligned, such that part of the second beam is received within the first cut-out volume and part of the first beam is received within the second cut-out volume, such that the first beam and the second beam interlock and the first upper surface and second upper surface lie in a single plane, and wherein the rail system comprises a locking arrangement configured to lock the first beam and the second beam together to prevent relative movement between the first beam and the second beam in at least a vertical direction.

21. The rail system according to claim 20, wherein the single plane is a horizontal plane.

22. The rail system according to claim 20, wherein an uppermost edge and the lowermost edge of the first beam define a height of the first beam and the uppermost edge and a lowermost edge of the second beam define a height of the second beam and wherein the height of the first beam and the height of the second beam are equal, and wherein the first cut-out extends upwards and the second cut-out extends downwards to the same level between 40% and 60% of the height.

23. The rail system according to claim 20, wherein the locking arrangement comprises a form-fitting locking member, configured to fit partially within a first form-fitting structure of the first beam and partially within a second form-fitting structure of the second beam, in order to secure the first and second beams together.

24. The rail system according to claim 23, wherein:
the at least one first form-fitting structure of the first beam comprises a first groove provided in at least one of the pair of first sidewalls,
the at least one second form-fitting structure of the second beam comprises a second groove provided in at least one of the pair of second sidewalls,
the first groove and the second groove lie in one plane parallel to the single plane,
and the locking member is configured to fit partially within the first groove and partially within the second groove to prevent relative movement of the first beam and the second beam in the vertical direction, and the locking member and the beams comprises a locking structure configured to lock the locking member against horizontal movement in its locking position by means of a snap fit connection and/or a form fit connection.

25. The rail system according to claim 24, wherein the form fit connection of the locking structure comprises an attachment hole located within the first or the second groove and a pin located on the locking member configured to extend, in its locking position, through the attachment hole, or the form fit connection comprises an upper and lower non-snap latch located on one of the two legs of the L-shaped locking member configured to form-lock behind an edge of the groove in which the locking member sits in its locking position and behind which edge the non-snap latch is arranged to be placed through an upper and lower gap in the edge.

26. The rail system according to claim 24, wherein the snap fit connection of the locking structure comprises an upper and lower snap locking latch located on one of the two legs of the L-shaped locking member configured to snap behind an edge of the groove in which the locking member sits in its locking position.

27. The rail system according to claim 26, wherein the cross-sections of the first groove and the second groove are identical.

28. The rail system according to claim 20, wherein cross-sections of the first and the second beam, except along the cut-outs, are identical.

29. The rail system according to claim 20, wherein the beams are made of extruded hollow chamber profiles.

30. The rail system according to claim 29, wherein the extruded hollow chamber profiles comprise two hollow chambers above each other and limited against each other by at least one wall bridging the lateral extent of the respective beam extending between the pair of sidewalls of the respective beam.

31. The rail system according to claim 30 in combination with claim 3, wherein the wall is located the level to which the first and the second cut-out extend.

32. The rail system according to claim 20, wherein the first cut-out extends upwards and the second cut-out extends downwards to a respective first and second surface which are horizontal and complementary to each other and which contact each other when the first and the second beams interlock.

33. The rail system according to claim 20, wherein the beams are made of an alloy comprising aluminium or an alloy comprising another light metal.

34. The rail system according to claim 20, wherein the first and/or the second upper surface is configured to provide two parallel tracks.

35. The rail system according to claim 20, comprising a plurality of first beams forming a first set of parallel rails, and a plurality of second beams forming a second set of parallel rails, the first set of parallel rails and the second set of parallel rails crossing each other and forming a rail grid.

36. The rail system according to claim 35, wherein each of the plurality of first beams extends across the whole rail grid of the rail system, and each of the plurality of second beams extends across the whole rail grid of the rail system.

37. An automated storage and retrieval system for storage and retrieval of containers, comprising:
a frame structure;
a rail system comprising a plurality of first beams forming a first set of parallel rails, and a plurality of second beams forming a second set of parallel rails, the first set of parallel rails and the second set of parallel rails crossing each other and forming a rail grid; and
a plurality of container handling vehicles, wherein the first set of parallel rails is arranged to guide movement of the container handling vehicles in a first direction (X) across the top of the frame structure, and the second set of parallel rails is arranged to guide movement of the container handling vehicles in a second direction (Y).

38. The automated storage and retrieval system according to claim 37, wherein the second beams comprise attachment means for attaching each second beam to the frame structure.
